(19) United States
(12) Patent Application Publication
(10) Pub. No.: US 2025/0002798 A1
(43) Pub. Date: Jan. 2, 2025

(54) METHOD OF TREATING WASTE PLASTIC

(71) Applicant: Neste Oyj, Espoo (FI)

(72) Inventors: Antti KURKIJÄRVI, Porvoo (FI); Marjut AHO, Porvoo (FI); Jarmo KELA, Porvoo (FI); Ville PAASIKALLIO, Porvoo (FI); Emma SAIRANEN, Porvoo (FI); Andrea PÉREZ NEBREDA, Porvoo (FI); Jukka KEYRILÄINEN, Porvoo (FI); Perttu UOTILA, Porvoo (FI); Mika KETTUNEN, Porvoo (FI); John JAMIESON, Porvoo (FI)

(73) Assignee: Neste Oyj, Espoo (FI)

(21) Appl. No.: 18/705,766

(22) PCT Filed: Oct. 28, 2022
(86) PCT No.: PCT/EP2022/080245

§ 371 Date: Apr. 29, 2024

(30) Foreign Application Priority Data
Oct. 29, 2021 (EP) 21205587.5
Oct. 29, 2021 (FI) 20216124

(51) Int. Cl. C10G 69/06; C10G 45/08

(52) U.S. Cl. CPC C10G 69/06; C10G 45/08; C10G 2300/1003; C10G 2300/202

(57) ABSTRACT

A method of processing liquefied waste plastic (LWP) includes hydrotreating a stream of liquified waste plastic (LWP) in a presence of hydrogen and a catalyst in a first hydrotreatment step in specified first (e.g., mild) hydrotreatment conditions, to form a stream of hydrotreated LWP, in a reactor system including at least one reactor each containing at least one catalyst bed; and blending the stream of hydrotreated LWP with a stream including hydrocarbons to form a mixed stream of hydrotreated LWP and hydrocarbons, and to provide a purified hydrocarbon product.

### FIELD OF THE INVENTION

The present invention relates to a method of treating waste plastic, especially liquified waste plastic treatment by hydrotreatment. The method includes removal of impurities and hydrogenation of the LWP. In detail, the method comprises two separate hydrotreatments of the LWP, where the second hydrotreatment is performed on a blend of hydrocarbons and already hydrotreated LWP.

### BACKGROUND OF THE INVENTION

Environmental concerns and a wish to limit the use of fossil based feedstock leads to a need to develop possibilities to use waste plastic. Waste plastic is a growing environmental concern, since many of the polymers constituting the plastics are very stable and do not degrade in nature. Incineration of waste plastic in-creases greenhouse gases and also leads to other environmental concerns in the form of air and land pollution. Incineration of waste plastic is largely considered a waste of valuable raw material, even if the energy in form of heat is collected.

Plastics or polymers mainly constitute carbon, hydrogen and heteroatoms such as oxygen and/or nitrogen. However, waste plastics also contain many impurities, such as metal and chlorine impurities. There is a growing interest in making use of waste plastic for producing various hydrocarbon components. Fuels are mixtures of hydrocarbons, but production of liquid fuels from waste plastic is generally not considered useful. Direct incineration of waste plastic also produces energy, which can be captured and used for heating and/or production of electricity etc. Therefore, there is a need to upgrade waste plastic to high end hydrocarbon components, which can be utilized in the production of new plastics, chemicals or other materials.

Waste plastics have been treated by pyrolysis to produce liquefied waste plastic (LWP), but the LWP feed still contains large amounts of various impurities and contaminants. The LWP feed therefore needs to undergo various purification and pre-treatment steps before it can be used as feedstock for various upgrading processes.

Document WO2021/110395 describes a process for treating a feed comprising waste plastic pyrolysis oil, the process includes a hydrogenation step at a temperature of 100° C. to 250° C., followed by a hydrotreatment step at a temperature of 250° C. to 430° C. The product thus obtained is further separated into a gaseous effluent, an aqueous effluent and a hydrocarbon effluent.

The current invention provides an improved process of treating and purifying LWP obtained e.g. through pyrolysis of waste plastic.

### BRIEF DESCRIPTION OF THE INVENTION

The present invention aims to provide an optimised solution for chemical recycling of waste plastics. The invention strives to make chemical recycling a viable and economical and thereby a complementary solution to recycled waste plastic streams that are not suitable for mechanical recycling. The chemical processes needed are devised in such a way that they can handle the complexities of chemical components in the waste products. Waste plastics are, on a general level, very heterogeneous materials. Depending on the polymer type and in what application it has been used, different plastic products will contain different types of additives such as pigments, fillers, flame retardants and so forth. When the waste plastic is converted into LWP via e.g. pyrolysis, the polymers and the various additives etc. will react/decompose in certain ways, and consequently a plurality of different compounds will be transferred into the product LWP. Conversion of LWP into higher quality value-added products entails the use of catalytic processes, and catalysts that are typically employed in such processes are sensitive to different impurities, i.e. the activity of the catalysts can be deactivated due to deposition of various catalyst poisons. It has been observed that LWP contains various impurities that are detrimental to catalysts, and consequently its further catalytic processing is technically more challenging e.g. when compared to conventional crude oil. This has led to the present invention, where these problems have been resolved by the process steps as claimed. Claimed process allows the processing of waste plastics to be made continuous and economical without having to worry about the damage and detrimental effects caused to the assets carrying out those processing.

The objects of the invention are achieved by a method characterized by what is stated in the independent claim. The preferred embodiments of the invention are disclosed in the dependent claims.

Therefore, an object of the current invention is to provide a method of processing liquefied waste plastic (LWP), wherein the method comprises step a) hydrotreating a stream of liquified waste plastic (LWP) in presence of hydrogen and a catalyst in a first hydrotreatment step in mild hydrotreatment conditions, to form a stream of hydrotreated LWP, in a reactor system comprising at least one reactor each containing at least one catalyst bed, step b) blending said stream of hydrotreated LWP with a stream comprising hydrocarbons to form a mixed stream of hydrotreated LWP and hydrocarbons.

### BRIEF DESCRIPTION OF THE DRAWINGS

In the following the invention will be described in greater detail by means of preferred embodiments with reference to the attached drawings, in which

FIG. 1 is a schematic view of a specific embodiment of the current invention. In FIG. 1 the dotted box=optional step; P1=Product 1; P2=Product 2; A1/A2=hydrotreatment step a); B=blending step b); C=hydrotreatment step c); CF=hydrocarbons stream.

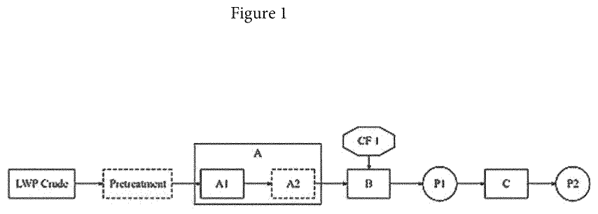

### DETAILED DESCRIPTION OF THE INVENTION

The current invention relates to a method of processing liquefied waste plastic, wherein the method comprises a first hydrotreatment of the LWP in mild conditions followed by blending the hydrotreated LWP with a stream comprising hydrocarbons.

With the term “liquefied waste plastic” is hereby meant a liquid product produced from any waste plastic through a non-oxidative thermolysis process. Typically, liquefied waste plastic is produced by pyrolysis of waste plastic. Other processes to produce LWP include but are not limited to hydrothermal liquefaction processes. The LWP is a mixture of hydrocarbonaceous organic components with a wide range of carbon chain lengths. Provided the large variations of carbon chain lengths and chemical structures and the properties of the LWP varies depending on the types of plastics (polymers) used in the production of LWP, the type of liquefaction process and conditions of the liquefaction process. Typical waste plastic feedstock used in the liquefaction method includes mainly polyethylene with varying amounts of polypropylene, polystyrene and other minor components such as polyamides, polyethylene terephthalate and polyvinyl chloride.

The liquefied waste plastic can be obtained by pyrolyzing waste plastic and subsequently collecting a liquid fraction from the pyrolyzed waste plastic. In a typical pyrolysis process, the solid waste plastic is heated to a temperature of 400-600° C. under non-oxidative conditions. The polymers thermally decompose and consequently release vapours and gases that exit the reactor in the gas phase. This vapor/gas stream is subsequently cooled down to condense the LWP product and to separate the gases. The LWP typically has a boiling range of about 40° C.-550° C., which corresponds approximately to carbon chain lengths of C5 to C55. Depending on the conversion technology, the final boiling point of the LWP can go up to 750° C.

LWP is a thermal cracking product of various polymers and is a complex mixture of mainly paraffins, olefins, naphthenes and aromatic hydrocarbons. The total amount of olefins is typically high, from 40 wt. % to 60 wt. %, whereas the amount of aromatic hydrocarbons is typically lower than 20 wt. %. LWP also contains heteroatoms, including oxygen, nitrogen, chlorine and sulphur, in the form of organic compounds with heteroatom substituents. The amounts of heteroatoms vary depending on the polymers used in production of LWP. Water is usually removed from the LWP product, but some dissolved water may still be present in the LWP.

The liquefied waste plastic can also undergo pre-treatment processes before the hydrotreatments according to the present invention. The LWP undergoes a pre-treatment step before hydrotreatment step a) and the pre-treatment step comprises reactive extraction, solvent extraction, adsorption, filtration, centrifugation, oxidation, reduction or any combination thereof.

According to the present invention, hydrotreatment step a) is defined as the first hydrotreatment step to be performed on the LWP in mild conditions. A stream of liquefied waste plastic (LWP) is subjected to a hydrotreatment step a) in the presence of hydrogen and a catalyst in mild conditions to form a stream of hydrotreated LWP. The mild conditions in the hydrotreatment step a) can be at a temperature from 100° C. to 350° C., preferably 170° C. to 340° C. Herein all temperatures of any hydrotreatment step are to be defined as the weighted average temperature of the reactor in which the hydrotreatment is performed, if nothing else is mentioned.

All of the hydrotreatments stated herein are performed in the presence of at least one catalyst. The catalyst may, for example, comprise at least one component selected from IUPAC group 6, 8 or 10 of the Periodic Table of Elements. When employing a supported catalyst, the catalyst preferably contains Mo and at least one further transition metal on a support. Examples of such a supported catalyst are a supported NiMo catalyst or a supported CoMo catalyst, or a mixture of both. In a supported catalyst, the support preferably comprises alumina and/or silica. These catalysts are usually employed as sulphided catalysts to ensure that the catalysts are in their active (sulphided) form. Turning the catalysts into their active (sulphided) form may be achieved by sulphiding them in advance (i.e. before starting the hydrotreatment reaction) and/or by adding a sulphur-containing feed (containing sulphur e.g. as an organic or inorganic sulphide). The feed may contain the sulphur from the start, or a sulphur additive may be admixed to the feed. In a preferable embodiment, the hydrotreating employs a catalyst and the catalyst is a supported NiMo catalyst and the support comprises alumina (NiMo/Al₂O₃) and/or the catalyst is a supported CoMo catalyst and the support comprises alumina (CoMo/Al₂O₃).

The catalyst of the hydrotreatment step a) is preferably supported NiMo, wherein the support preferably comprises alumina and/or silica.

The conditions of the hydrotreatment step a) are preferably selected from the following:
a H2 to oil ratio is 200-450 Nm3/stdm3, preferably 220-400 Nm3/stdm3;
a LHSV of 0.1-2.0 h⁻¹, preferably 0.2-0.5 h⁻¹
a temperature of 100-350° C., preferably 170-340° C.
a pressure of 4000-6000 kPa(a), preferably 4800-5500 kPa(a)

In one embodiment of the current invention the hydrotreatment step a) is repeated before the subsequent blending step. The hydrotreatment step a) can be repeated to ensure sufficient hydrotreatment of LWP in the stream. The possible need for repeating the hydrotreatment step a) depends on among others, on the hydrotreatment conditions, the hydrotreatment catalyst and reactor design, such as number of reactors, type of catalyst beds and number of catalyst beds in the reactors and so forth.

In one embodiment of the current invention the stream of LWP consists only of LWP and the hydrotreatment in step a) is performed only on LWP. In this specific embodiment, the hydrotreatment a) in mild hydrotreatment conditions is performed solely on a stream containing only LWP and no other streams are directed to the first hydrotreatment step (step a) in claims). The hydrotreatment step a) in this embodiment is a step where only components of the stream of LWP originating from waste plastic are hydrotreated in the mild hydrotreatment conditions.

In one embodiment of the current invention the hydrotreatment step a) includes a step where a part of the formed stream of hydrotreated LWP from the hydrotreatment step a) is recycled back to the reactor carrying out the hydrotreatment step a). The amount of recycling, if present, depends among others on the hydrotreatment conditions, the hydrotreatment catalyst and reactor design, such as number of reactors, type of catalyst bed and number of catalyst beds in the reactors.

As a result of the hydrotreatment step a), a stream of first hydrotreated LWP is formed. The formed hydrotreated LWP stream contains lower amounts of impurities, contaminants and harmful components compared to the before hydrotreated LWP feed. With impurities, contaminants and harmful components is herein meant any substance, compound or composition which have detrimental properties to any component, equipment or catalyst downstream of the hydrotreatment. Especially harmful components are compounds containing hetero atoms, metals and metalloids. Especially harmful hetero atoms include halogens such as chlorine. Especially harmful metals include but are not limited to mercury, lead, sodium, arsenic, vanadium, iron, zinc and aluminium. Compounds containing silicon, phosphorous, oxygen, nitrogen and sulphur can also be problematic downstream from the hydrotreatment, if not removed. Furthermore, the conjugated di-olefins and olefins are considered agents causing coking or fouling which have to be minimised from the LWP in order for the treated LWP to be used downstream as a feedstock for steam cracking for example.

The purpose of hydrotreating a stream of liquified waste plastic (LWP) according to the invention is to reduce the risk of harmful and/or detrimental properties of any of the impurities, contaminants and harmful components, which might be present in the LWP. The hydrotreating step reduces the amount of these components and therefore reduces the risks and harms they would otherwise pose on any component, equipment or catalyst downstream of the hydrotreatment. After the hydrotreatment step a) in mild hydrotreatment conditions as specified, the conjugated diolefin content in the LWP is reduced to below 0.2 wt. %.

The method of the current invention further comprises blending the stream of hydrotreated LWP obtained from mild hydrotreatment step a), with a stream comprising hydrocarbons to form a mixed stream comprising hydrotreated LWP and hydrocarbons. The stream comprising hydrocarbons would have a different impurities profile than the LWP feed being subjected to the hydrotreatment step a), since said hydrocarbons is of any origins other than LWP thus “hydrocarbons” and “hydrocarbons of other origins” are to mean synonymously.

In one embodiment of the current invention hydrocarbons of other origins in the form of stream is selected from vacuum gas oil (VGO) fraction, gas oil (GO) fraction, heavy gas oil (HGO) fraction, kerosene fraction, light gas oil fraction, atmospheric residue (AR) fraction, vacuum residue (VR) fraction and deasphalted oil (DAO) fraction. The other suitable hydrocarbon streams to be used for blending include a crude oil-derived feedstock comprising at least one crude oil-fraction, or a bio-based fats or oils or fatty acids, or lignocellulosic based hydrocarbons, or Fischer Tropsch or other synthetic hydrocarbons.

In one embodiment the stream comprising hydrocarbons have one or more of the following properties:
a boiling point range from 60° C.-700° C., most preferably from 100° C.-600° C., boiling point can be measured according to ASTMD2887, or EN15199-2 depending on the boiling point range;
a molecular weight of 250-400 g/mol, most preferably 280-350 g/mol, as measured according to ASTMD2887;
aromatics content >10 wt. %, most preferably >35 wt. %, as measured according to ASTMD2549;
density from 870-940 kg/m³, most preferably 890-920 kg/m³, as measured according to ENISO12185;
a sulphur content of <5 wt. %, preferably <1.8 wt. %;
bromine number <10 g Br/100 g, preferably <4 g Br/100 g according to IS03839M;
asphaltenes content of <300 mg/kg, preferably 250 mg/kg according to TOTAL642; and
a silicon content of <2.5 mg/kg, preferably <1 mg/kg according to ASTMD5185.

According to one embodiment of the invention the mixed stream of hydrotreated LWP and hydrocarbons is kept at a temperature of at least 140° C. before subjecting the mixed stream to the subsequent hydrotreatment step c), preferably said mixed stream comprising hydrotreated LWP and hydrocarbons is kept at a temperature of from 140° C. to 370° C., more preferably from 200° C. to 350° C. Keeping the mixed stream at an elevated temperature to ensure sufficient mixing of the two streams. Mixing at an elevated temperature also ensures no or minimal precipitation of impurities. The stream of hydrocarbons to be blended with the hydrotreated LWP will typically have a higher temperature compared to the stream of hydrotreated LWP.

According to one embodiment of the invention the mixed stream of hydrotreated LWP and hydrocarbons contains up to 70 wt. % LWP based on total weight of stream, preferably the content of LWP in said stream is from 5 wt. % to 70 wt. %, more preferably from 10 wt. % to 50 wt. % and even more preferably from 15 wt. % to 30 wt. %.

According to one embodiment of the current invention the method further comprises
c) hydrotreating said mixed stream of hydrotreated LWP and hydrocarbons in the presence of hydrogen and a catalyst in severe hydrotreatment conditions to provide a refined stream.

The hydrotreatment step c) is defined by its severe conditions which can be carried out at a temperature of 355° C. to 400° C., preferably 360° C. to 390° C. In addition, hydrotreatment step c) is referred to as the hydrotreatment step subsequent to hydrotreatment step a) after the hydrotreated stream of step a) has been blended with a stream of hydrocarbons of other origins.

In one embodiment of the present invention, the catalyst of the hydrotreatment step a) and c) is a supported catalyst, and the catalyst preferably comprises at least one component selected from IUPAC group 6, 8 or 10 of the Periodic Table of Elements. Furthermore, the supported catalyst can contain Mo and at least one further transition metal on a support, such as a supported NiMo catalyst or a supported CoMo catalyst, wherein the support preferably comprises alumina and/or silica. In particular, the catalyst is a supported CoMo catalyst and the support comprises alumina (CoMo/Al₂O₃) and/or the catalyst is a supported NiMo catalyst and the support comprises alumina (NiMo/Al₂O₃).

The conditions of the hydrotreatment step c) are preferably selected from the following:
a H2 to oil ratio is 150-400 Nm³/stdm³, preferably 180-250 Nm³/stdm³;
a LHSV of 0.5-2.0 h⁻¹, preferably 1.1-1.5 h⁻¹;
a temperature of 355-400° C., preferably 360-390° C.
a pressure of 4000-6000 kPa(a), preferably 4800-5500 kPa(a).

In one embodiment, hydrotreatment steps a) and c) can be carried out respectively in a single reactor unit comprising at least one catalyst bed. In another embodiment, hydrotreatment step a) and c), can be carried out respectively in a reactor system comprising at least two reactor units, wherein each reactor unit contains at least one catalyst bed.

In one embodiment of the present invention, hydrogen is being mixed with the LWP before carrying out hydrotreatment step a) and/or step c).

In one embodiment of the invention, the LWP undergoes a pre-treatment step before hydrotreatment step a) and the pre-treatment step comprises reactive extraction, solvent extraction, adsorption, filtration, centrifugation, oxidation, reduction or any combination thereof.

In one embodiment the method further comprises a step of adding water to said process and/or removal of an aqueous phase from said process after said hydrotreatment step a) and/or after said hydrotreatment c). In one embodiment of the current invention, water is added to the process after any of the hydrotreatment steps in order to remove impurities. The impurities are or become water soluble in the hydrotreatment and can thus be removed by washing the hydrotreated LWP stream with water. The water soluble impurities are dissolved in the water stream and the aqueous phase containing the impurities is then decanted from the hydrotreated LWP stream.

In one embodiment of the invention, the method further comprises a step of subjecting the refined stream after the hydrotreatment step c), to one or more fractionation step(s) to form two or more product streams. Preferably the fractionated product streams include a naphtha fraction having a 5-95 wt. % boiling point range of 30-200° C., preferably from about 30° C. to about 180° C., more preferably from about 30° C. to about 110° C., and a middle distillate fraction having a 5-95 wt. % having a boiling point from about 150° C. to about 400° C., preferably from about 160° C. to about 360° C., and more preferably from about 160° C. to about 330° C., and a liquefied petroleum gas (LPG) fraction comprising one or more of ethane, propane or butane. The naphtha fraction can further be subjected to steam cracking, and/or the middle distillate can further be subjected to steam cracking, and/or the LPG fraction can further be subjected to steam cracking.

In one further embodiment of the current invention, hydrotreatment step a) and hydrotreatment step c) are carried out in a reactor system comprising one or more reactors, each reactor having one or more catalyst beds and at least one reactor with a direct hydrogen feed to the reactor. The reactor designated for the hydrotreatment step a) and c) can also be carried out respectively in separate reactors, each having a plurality of independent catalyst beds and independent reaction temperatures, or any combination thereof.

In one embodiment of the present invention, it further relates to a LWP product, P1, obtainable by hydrotreating LWP according to hydrotreatment step a) and blending according to step b) and wherein the product comprises
a reduced amount of silicon to be below 6 mg/kg, more preferably <1 mg/kg, and/or phosphorous to be below 5 mg/kg, more preferably 1 mg/kg, as measured by ICP-MS/MS,
a low ratio of diolefin to total olefin content to be below 0.01, more preferably below 0.001, measured by ASTMD8071
a low ratio of conjugated diolefin to non-conjugated diolefin to be below 2, more preferably below 1, measured by ASTMD8071
a halogen content to be under 5 mg/kg, preferably 1 mg/kg

Metals measurement by ICP-MS/MS is performed on a sample that is warmed to liquid if needed prior to weighing. It is digested with acids in the micro-wave oven to a clear water/acid matrix, diluted to a known amount and analysed against the acid based calibration using ICP-MS/MS. Low elemental results are determined as ppb (μg/kg).

In one embodiment of the invention, the method further comprises a step of subjecting the refined stream after the hydrotreatment step a), and blending step b), i.e., product P1, to one or more fractionation step(s) to form two or more product streams. Preferably the fractionated product streams include a naphtha fraction having a 5-95 wt. % boiling point range of 30-200° C., preferably from about 30° C. to about 180° C., more preferably from about 30° C. to about 110° C., and a middle distillate fraction having a 5-95 wt. % having a boiling point from about 150° C. to about 400° C., preferably from about 160° C. to about 360° C., and more preferably from about 160° C. to about 330° C., and a liquefied petroleum gas (LPG) fraction comprising one or more of ethane, propane or butane. The naphtha fraction can further be subjected to steam cracking, and/or the middle distillate can further be subjected to steam cracking, and/or the LPG fraction can further be subjected to steam cracking.

It will be obvious to a person skilled in the art that, as the technology advances, the inventive concept can be implemented in various ways. The invention and its embodiments are not limited to the examples described above but may vary within the scope of the claims.

1-22. (canceled)

23. A method of processing liquefied waste plastic (LWP), wherein the method comprises:
step a) hydrotreating a stream of liquified waste plastic (LWP) in a presence of hydrogen and a catalyst in a first hydrotreatment step in first hydrotreatment conditions, to form a stream of hydrotreated LWP, in a reactor system including at least one or more reactors each containing at least one catalyst bed; and
step b) blending said stream of hydrotreated LWP with a stream including hydrocarbons to form a mixed stream of hydrotreated LWP and hydrocarbons.

24. The method according to claim 23, comprising:
step c) hydrotreating said mixed stream of hydrotreated LWP and hydrocarbons in a presence of hydrogen and a catalyst in second hydrotreatment conditions, which are more severe hydrotreatment conditions as compared to more mild conditions of the first hydrotreatment conditions, to provide a refined stream.

25. The method according to claim 23, wherein the first hydrotreatment conditions of said hydrotreatment step a) include a temperature within a range from 100° C. to 350° C.

26. The method according to any claim 24, wherein the second, more severe, hydrotreatment conditions of said hydrotreatment step c) include a temperature within a range of from 355° C. to 400° C.

27. The method according to claim 23, comprising:
a pretreatment step for the stream of LWP before hydrotreatment step a), wherein the pre-treatment step includes at least one or more of reactive extraction, solvent extraction, adsorption, filtration, centrifugation, oxidation, reduction and/or any combination thereof.

28. The method according to claim 23, wherein said stream including hydrocarbons is a crude oil-derived feedstock containing at least one crude oil-fraction or a bio-based fats or oils or fatty acids, or lignocellulosic based hydrocarbons, or Fischer Tropsch hydrocarbons, wherein the crude oil fraction is selected from at least one or more of vacuum gas oil (VGO) fraction, gas oil (GO) fraction, heavy gas oil (HGO) fraction, kerosene fraction, light gas oil fraction, atmospheric residue (AR) fraction, vacuum residue (VR) fraction and/or deasphalted oil (DAO) fraction.

29. The method according to claim 24, comprising:
keeping the mixed stream including hydrotreated LWP and hydrocarbons at a temperature within a range of 140° C. to 370° C. before subjecting it to said hydrotreatment step c), and/or keeping said mixed stream of hydrotreated LWP and hydrocarbons at a temperature within a range of 200 to 350° C.

30. The method according to claim 23, wherein said mixed stream of hydrotreated LWP and hydrocarbons contains up to 70 wt. % LWP based on a total weight of the stream, and/or a content of LWP in said stream is within a range of from 5 wt. % to 70 wt. %, and/or from 10 wt. % to 50 wt. % and/or from 15 wt. % to 30 wt. %.

31. The method according to claim 23, wherein the catalyst in said hydrotreatment step a) is a supported catalyst, and the catalyst comprises:
at least one component selected from IUPAC group 6, 8 or 10 of the Periodic Table of Elements.

32. The method according to claim 30, wherein the supported catalyst contains Mo and at least one further transition metal on a support, the support being a supported NiMo catalyst or a supported CoMo catalyst, wherein the support includes alumina and/or silica.

33. The method according to claim 31, wherein the catalyst is a supported CoMo catalyst, and the support comprises:
alumina (CoMo/Al₂O₃) and/or the catalyst is a supported NiMo catalyst and the support includes alumina (Ni-Mo/Al₂O₃).

34. The method according to claim 23, comprising:
a step of adding water and/or removing of an aqueous phase from said process after said hydrotreatment step a) and/or after said hydrotreatment step c).

35. The method according to claim 23, comprising:
repeating said hydrotreatment step a) before the step of blending said stream of hydrotreated LWP with a stream including hydrocarbons to form a mixed stream of hydrotreated LWP and hydrocarbons.

36. The method according to claim 23, wherein the stream of LWP consists only of LWP and the hydrotreatment step a) is performed only on LWP.

37. The method according to claim 23, comprising:
performing said hydrotreatment step a) in conditions which include:
a H2 to oil ratio in a range of 200-450 Nm³/stdm³, and/or 220-400 Nm³/stdm³;
a LHSV in a range of 0.1-2.0 h⁻¹, and/or 0.2-0.5 h⁻¹; and
a temperature in a range of 100-350° C., and/or 170-340° C.

38. The method according to claim 24, comprising:
performing said hydrotreatment step c) in conditions which include:
a H2 to oil ratio in a range of 150-400 Nm³/stdm³, and/or 180-250 Nm³/stdm³;
a LHSV in a range of 0.5-2.0 h−¹, and/or 1.0-1.5 h⁻¹; and
a temperature in a range of 355-400° C., and/or 360-390° C.

39. The method according to claim 24, comprising:
a step of subjecting said refined stream to one or more fractionation step(s) to form two or more product streams, and/or the product streams include a naphtha fraction having a 5-95 wt. % boiling point in a range of from 30-200° C., and/or from about 30° C. to about 180° C., and/or from about 30° C. to about 110° C., and a middle distillate fraction having a 5-95 wt. % having a boiling point in a range from about 150° C. to about 400° C., and/or from about 160° C. to about 360° C., and/or from about 160° C. to about 330° C.

40. The method according to claim 39, comprising:
subjecting the naphtha fraction to steam cracking, and/or subjecting the middle distillate to steam cracking, and/or subjecting the LPG fraction to steam cracking.

41. The method according to claim 24, comprising:
carrying out hydrotreatment steps a) and c) respectively in a single reactor unit including at least one catalyst bed, or carrying out hydrotreatment step a) and c), respectively in a reactor system including at least two reactor units, wherein each reactor unit contains at least one catalyst bed, or any combination thereof.

42. The method according to claim 23, wherein the at least one reactor has a direct hydrogen quench to the reactor.

43. The method according to claim 24, comprising:
mixing hydrogen with the stream of LWP before carrying out hydrotreatment step a) and step c).

44. A purified hydrocarbon product, obtained from the method of claim 23, by hydrotreating LWP according to hydrotreatment step a) and blending according to step b), and wherein the product comprises:
a reduced amount of silicon to be below 6 mg/kg, and/or <1 mg/kg, and/or phosphorous to be below 5 mg/kg, and/or 1 mg/kg, as measured by ICP-MS/MS;
a low ratio of diolefin to total olefin content to be below 0.01, and/or below 0.001, measured byASTMD8071;
a low ratio of conjugated diolefin to non-conjugated diolefin to be below 2, and/or below 1, measured by ASTMD8071; and
a halogen content to be under 5 mg/kg, and/or 1 mg/kg.
